(19) United States
(12) Patent Application Publication
(10) Pub. No.: US 2024/0217238 A1
(43) Pub. Date: Jul. 4, 2024

(54) A NOZZLE PLATE FOR A DROPLET EJECTION HEAD, A DROPLET EJECTION APPARATUS AND A METHOD FOR OPERATING THE SAME

(71) Applicant: Xaar Technology Limited, Huntingdon (GB)

(72) Inventor: Lukasz KUBAN, Huntingdon (GB)

(21) Appl. No.: 18/573,031

(22) PCT Filed: Jun. 23, 2022
(86) PCT No.: PCT/GB2022/051598

§ 371 Date: Dec. 21, 2023

(30) Foreign Application Priority Data
Jun. 24, 2021 (GB) 2109076.6

(51) Int. Cl. B41J 2/14

(52) U.S. Cl. CPC B41J 2/1433; B41J 2/14209; B41J 2002/14475

(57) ABSTRACT

A nozzle plate for a droplet ejection device: comprising a first, media facing surface and, opposing it, a second, back surface; and at least one nozzle: wherein said at least one nozzle passes through the nozzle plate from the second surface to the first surface; and wherein said at least one nozzle comprises an exit bore having an exit bore centreline and wherein the exit bore centreline is inclined at an oblique inclination angle θ to the first surface and is adapted such that, in use, one or more droplets will be ejected from the nozzle at an acute inclination angle θ to the first surface. A droplet ejection device comprising the nozzle plate. A droplet ejection apparatus comprising at least one droplet ejection device and a deposition media movement apparatus and a method of operating the droplet ejection apparatus.

### FIELD OF INVENTION

The present invention relates to a nozzle plate for a droplet ejection device, a droplet ejection device and a droplet ejection apparatus comprising the droplet ejection device: it further relates to a method of operating the droplet ejection apparatus. The nozzle plate may be used with particular benefit in applications that require printing a high resolution image onto a textured or flexible surface at high speeds. The nozzle plate may be particularly suitable for a drop-on-demand inkjet printhead.

### BACKGROUND

Droplet ejection heads are now in widespread usage, whether in more traditional applications, such as inkjet printing, or in 3D printing and other rapid prototyping techniques. Droplet ejection heads have been developed that are capable of use in industrial applications, for example for printing directly onto substrates such as ceramic tiles or textiles: or onto bottles or other 3D objects. Such industrial printing techniques using droplet ejection heads allow for short production runs, customization of products and even printing of bespoke designs.

Droplet ejection heads therefore continue to evolve and specialize so as to be suitable for new and/or increasingly challenging applications. However, while a great many developments have been made in the field of droplet ejection heads, there remains room for improvements.

In recent years, there has been increasing interest in high speed printing involving higher relative motion between printhead and deposition media, however doing so can lead to a problem commonly referred to as “woodgrain”. In order to explain this problem, reference is initially made to a known test apparatus, such as that of FIG. 1A, which shows a schematic cross-section through a droplet ejection apparatus 1 comprising a droplet ejection device, such as a droplet ejection head 2, mounted above a deposition media 3 movable by a transport mechanism 5. The droplet ejection head 2 comprises a nozzle plate 6 having nozzles 11 for ejecting droplets onto the deposition media 3 in response to signals sent by a controller 4. The nozzle plate 6 has a media facing surface 18 opposite the deposition media 3 and the ejected droplets of fluid exit the nozzles 11 through respective nozzle outlets in the media facing surface 18. The droplet ejection head 2 is mounted such that there is a gap G between the deposition media 3 and the droplet ejection head 2. The nozzle plate 6 is shown in greater detail in the schematic cross-section of FIG. 1B, where it can be seen that the nozzle 11 has a nozzle inlet 15 and a nozzle outlet 14, and that the nozzle 11 is perpendicular to the media facing surface 18.

In some circumstances, a “woodgrain” effect may be experienced when operating the test apparatus 1 using the nozzle plate 6 in a droplet ejection head 2 for high print velocities. As used herein, the “woodgrain” effect is an unwanted printing artefact thought to be the result of induced, or forced air flow 121 into the gap G between the nozzle plate 6 of the droplet ejection head 2 and the deposition media 3 that is being printed upon, due to the relative motion between the droplet ejection head 2 and the deposition media 3. The forced air flow 121 due to higher velocity movement between droplet ejection head and deposition media can cause significant and uncontrollable deviation in the trajectory 120 of the ejected droplets (shown schematically with a dotted line in FIG. 1A), such that the initial direction of travel ti (as indicated by an arrow in FIG. 1A and FIG. 1B) of the droplets as they leave the nozzles 11 is vertically downward, toward the deposition media. The forced air flow 121 affects the trajectory 120 taken by the droplets as they traverse the gap G, altering their landing position in the x and/or y directions, as well as causing mist and satellites to accumulate in unpredictable locations on the deposition media. Mist and satellites may also land on the portions of the droplet ejection head 2 surrounding the nozzles 11. One visual effect seen on the deposition media may be that of an undulating “woodgrain” pattern, but the effect may result in other irregular patterns appearing visibly in the printed image. Woodgraining may particularly be experienced in applications that require a greater gap G, for example where the surface of the deposition media 3 is rough, flexible or textured, such as textiles, cartons or cardboard packaging.

An illustration of a typical woodgrain pattern is shown in the test print sample in FIG. 1C. The test print sample was achieved using the OpenFOAM™ computational fluid dynamics (CFD) modelling tool to simulate the result of ejecting at full duty (all nozzles printing) using the head arrangement of FIG. 1A, with a nozzle spacing of 84.7 μm (300 nozzles per inch) and a gap G distance of 3 mm. The media speed for this sample was 80 m/min and the measured drop velocity at 1 mm distance from the nozzle plate was 6.1 ms⁻¹. The pattern that might be expected in the absence of the woodgrain effect would be one of uniform coverage. For example, if nozzles 11 are arranged in a row along the droplet ejection head 2 in the y-direction, so as to span the deposition media 3, and are all positioned at the same x position, x1, and all eject a droplet at the same time t1, for uniform coverage those droplets would all land on the deposition media 3 at the same x position, x2 and at the same y position as the nozzle 11 from which the droplet originated, e.g. a droplet leaving a nozzle 11 at a y position y1 would land at the same y position y1 on the deposition media 3. By the same position, in x or y, it may be understood that this may encompass positions so close to the intended target as to be indistinguishable to the naked eye. The simulated pattern, as shown in FIG. 1C, is that caused by main droplet deviation (where the “main droplet” signifies a droplet of or near a desired target volume), resulting in dark “veins” forming an irregular, branching and undulating pattern across the image in the y direction and along the media transport direction x, and resembling a woodgrain pattern. This main droplet deviation can be due to induced flows in the gap G causing some droplets to fall short of the x2 position and some to overshoot it, such that even when a row of nozzles 11 spanning the y-direction of the droplet ejection head eject droplets at the same time, t1, from the same x position x1, they land on the deposition media 3 over a range of x positions xR, as indicated in FIG. 1A. Similarly, there may be deviation of droplets in the y-direction. Woodgraining may not only be due to a deviation of the main droplet. The various flows can also give rise to mist or satellites and cause these to form visible variations in print density perceived as “woodgrain”.

In some applications, it is desirable to use a droplet ejection apparatus 1, such as that shown in FIG. 1A, in which the droplet ejection head 2 is rigidly mounted and the deposition media 3, to be printed on, is passed underneath it. This is often referred to as single pass printing. In this apparatus set up, the moving deposition media 3 creates the forced air flow in the gap G (indicated by horizontal arrows 122 in FIG. 1A), with a velocity profile that is characteristic of the single pass printing situation. More generally, whether the droplet ejection head 2 is moved with respect to the deposition media 3, or the deposition media 3 is moved with respect to the droplet ejection head 2, a velocity difference exists between the droplet ejection head 2 and the deposition media 3, which gives rise to forced air flow around the droplet ejection head 2, and/or in the gap G between the droplet ejection head 2 and the deposition media 3 and leads to the woodgrain effect. The present invention aims to reduce or eliminate the woodgrain effect.

### SUMMARY

Aspects of the invention are set out in the appended independent claims, while details of particular embodiments of the invention are set out in the appended dependent claims.

According to a first aspect of the invention, there is provided a nozzle plate for a droplet ejection device: comprising a first, media facing surface and, opposing it, a second, back surface; and at least one nozzle: wherein said at least one nozzle passes through the nozzle plate from the second surface to the first surface; and wherein said at least one nozzle comprises an exit bore having an exit bore centreline and wherein the exit bore centreline is inclined at an oblique inclination angle θ to the first surface and is adapted such that, in use, one or more droplets are ejected from the nozzle at an acute inclination angle θ to the first surface.

According to certain embodiments, there is provided a nozzle plate according to the first aspect, wherein the nozzle plate has a leading edge and a trailing edge and the exit bore centreline is inclined in a direction towards said trailing edge.

According to certain embodiments, there is provided a nozzle plate according to the first aspect, wherein preferably the inclination angle θ is between 74° and 68°: more preferably wherein the inclination angle θ is between 72° and 70°.

According to certain embodiments, there is provided a nozzle plate according to the first aspect, wherein at least a portion of the exit bore along the exit bore centreline has a circular cross-section.

According to certain embodiments, there is provided a nozzle plate according to the first aspect, wherein the nozzle plate comprises a plurality of said nozzles.

According to certain embodiments, there is provided a nozzle plate according to the first aspect, wherein the nozzle plate comprises a plurality of said nozzles and the exit bore centrelines of the plurality of said nozzles are parallel to each other.

According to certain embodiments, there is provided a nozzle plate according to the first aspect, wherein the nozzle plate comprises a plurality of said nozzles and wherein the plurality of said nozzle exit bores are substantially identical to each other.

According to certain embodiments, there is provided a nozzle plate according to the first aspect, wherein the nozzle plate comprises one or more arrays of nozzles.

According to a second aspect of the invention, there is provided a droplet ejection device comprising a nozzle plate according to the first aspect of the invention.

According to certain embodiments, there is provided a droplet ejection device according to the second aspect, comprising a trailing edge, wherein the trailing edge of the droplet ejection head is parallel to the trailing edge of the nozzle plate.

According to certain embodiments, there is provided a droplet ejection device according to the second aspect, comprising at least one fluid chamber, located adjacent to and fluidically connected to said at least one nozzle, and adapted so as, in use, to supply fluid to be ejected through said at least one nozzle.

According to a third aspect of the invention, there is provided a droplet ejection apparatus comprising at least one droplet ejection device according to the second aspect of the invention and a deposition media movement apparatus.

According to certain embodiments, there is provided a droplet ejection apparatus according to the third aspect, wherein the deposition media movement apparatus is arranged such that, in operation, at least a portion of the deposition media is positioned parallel to the first surface of the nozzle plate while it is moved by the deposition media movement apparatus.

According to certain embodiments, there is provided a droplet ejection apparatus according the third aspect, wherein said droplet ejection apparatus is arranged as a single-pass printer.

According to a fourth aspect of the invention, there is provided a method of operating a droplet ejection apparatus according to the third aspect of the invention, comprising ejecting droplets from the at least one nozzle at an acute inclination angle θ to the first surface.

According to certain embodiments, there is provided a method of operating a droplet ejection apparatus according to the fourth aspect, wherein the inclination angle θ is between 74° and 68°.

According to certain embodiments, there is provided a method of operating a droplet ejection apparatus according to the fourth aspect, wherein the apparatus has a width in a y-direction and droplets are ejected from a plurality of nozzles extending in the y direction and wherein a standard deviation of landing positions of the ejected droplets on the deposition media in the y-direction is less than 8.3.

According to certain embodiments, there is provided a method of operating a droplet ejection apparatus according to the fourth aspect, wherein the droplet ejection apparatus is operating in single-pass printing mode.

### BRIEF DESCRIPTION OF THE DRAWINGS

FIG. 1A is a schematic cross-section of a test apparatus;

FIG. 1B is a schematic cross-section of the test nozzle plate of FIG. 1A;

FIG. 1C is a simulation of an image printed by the test apparatus of FIG. 1A;

FIG. 2A is a schematic cross-section of a nozzle plate according to an embodiment of the invention;

FIG. 2B is a schematic cross-section of a part of the nozzle plate of FIG. 2A;

FIG. 3A is a schematic cross-section of a nozzle plate according to another embodiment of the invention;

FIG. 3B is a schematic cross-section of a nozzle plate according to another embodiment of the invention;

FIG. 4A is a schematic drawing of a droplet ejection apparatus comprising the nozzle plate of FIG. 2A;

FIG. 4B is a schematic drawing of a portion of a droplet ejection device according to an embodiment of the invention, suitable for use in a droplet ejection apparatus such as that of FIG. 4A;

FIG. 5A is a simulation of a printed image generated using computation fluid dynamics (CFD) for a droplet ejection device of a conventional design (Test Case);

FIG. 5B is a simulation of a printed image generated using computation fluid dynamics (CFD) for a droplet ejection device according to an embodiment of the invention (Embodiment Case);

FIG. 6A is a simulation of the fluid flow of a cross-section in a z-x plane in the gap G for the Test Case, under the same simulation conditions as FIG. 5A; and

FIG. 6B is a simulation of the fluid flow of a cross-section in a z-x plane in the gap G for the Embodiment Case, under the same simulation conditions as FIG. 5B.

It should be noted that the drawings are not to scale and that certain features may be shown with exaggerated sizes so that these are more clearly visible.

### DETAILED DESCRIPTION OF THE DRAWINGS

Embodiments and their various implementations will now be described with reference to the drawings. Throughout the following description, like reference numerals are used for like elements where appropriate.

### Nozzle Plate

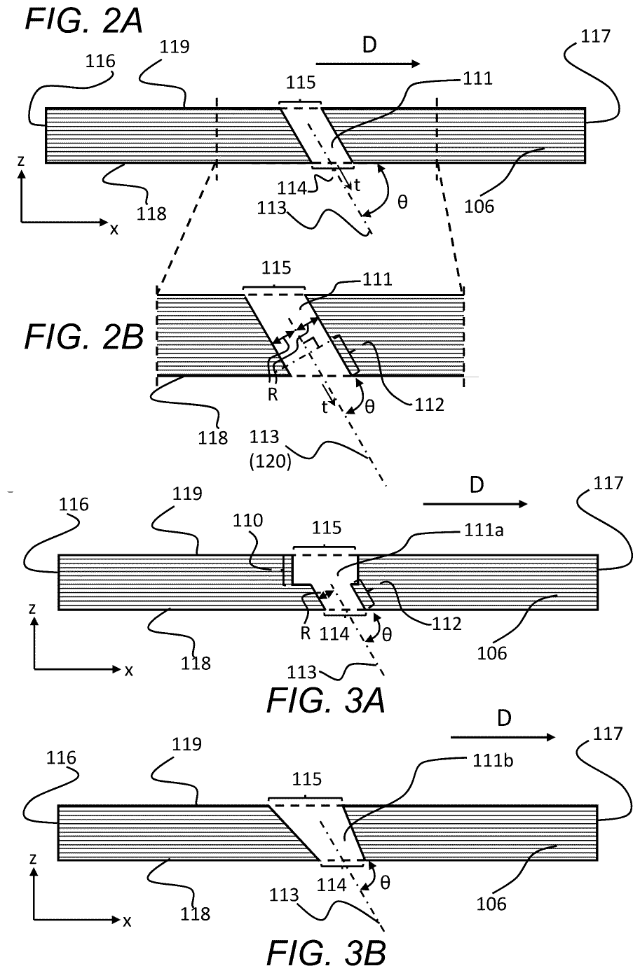

FIG. 2A portrays a nozzle plate 106 for a droplet ejection device and FIG. 2B depicts an enlarged detail of the nozzle plate 106 of FIG. 2A. The nozzle plate 106 has a first, media facing surface 118 and, opposing it, a second, back surface 119. The nozzle plate 106 further comprises a nozzle 111 that passes through the nozzle plate 106 from the second, back surface 119 to the first, media facing surface 118 such that it has a nozzle inlet 115 on the second, back surface 119 and a nozzle outlet 114 on the first, media facing surface 118. The nozzle 111 has an exit bore 112 having an exit bore centreline 113 which is inclined at an acute (less than 90°) inclination angle θ to the first, media facing surface 118 and is adapted such that, in use, fluid, such as a droplet or a series of droplets, will be ejected from the nozzle 111 travelling at an acute inclination angle θ to the first, media facing surface 118. Phrased differently, it can be said that the initial direction of travel ti2 of the droplet (or a series of droplets) as it (or they) leave the nozzle outlet 114 will be parallel to the centreline 113, where the exit bore centreline 113 is inclined at an oblique inclination angle θ to the first, media facing surface 118. As can be seen from FIG. 2B, the exit bore 112 is the portion of the nozzle 111 adjacent to the first, media facing surface 118, such that it is the final portion of the nozzle 111 before the nozzle outlet 114.

In the embodiment shown in FIG. 2A and FIG. 2B, a bore of the nozzle 111 has a constant cross-section perpendicular to the exit bore centreline 113, along its entire length such that the bore of the entire nozzle 111 has the same cross-sectional shape throughout: however, it may be understood that this is by no means essential. It may further be seen from FIG. 2B that the nozzle 111 has a cylindrical shape, with a circular cross-section, of radius R, along the length of the exit bore centreline 113. Again, it may be understood that this is by no means essential, and in other arrangements other cross-sections may be used. It may further be understood that in other arrangements other cross-sectional shapes and cross-sectional areas may be used, either along a portion, or the entirety of the bore, or the cross-sectional shape may vary in a continuous or discontinuous manner.

Considering FIG. 2A further, it can be seen that, in this arrangement, the nozzle plate 106 has a leading edge 116 and a trailing edge 117 where the exit bore centreline 113 is inclined in a direction towards the trailing edge 117. In other words, the inclination angle θ between the exit bore centreline 113 and the first, media facing surface 118 is at an acute angle such that the exit bore centreline 113 is angled towards the trailing edge 117. When the nozzle plate is installed in a droplet ejection device, the leading edge will be the edge of the nozzle plate which is oriented upstream in the deposition media movement direction, and the trailing edge will be downstream in the deposition media movement direction. Preferably, the inclination angle θ may be between 74° and 68°. More preferably, the inclination angle θ may be between 72° and 70°. In some arrangements, the preferred inclination angle θ may be 70°.

Turning now to FIG. 3A, this depicts another embodiment of the nozzle plate of the invention, similar to that of FIG. 2A and FIG. 2B, but where, in addition to the exit bore 112, the nozzle 11 la has an inlet portion 110. The exit bore 112 is similar to that of FIGS. 2A and 2B, with a circular cross-section, perpendicular to the exit bore centreline 113, of radius R. In some arrangements, the exit bore 112 may have the same cross-section throughout: in others only a portion of the exit bore may have the same cross-section. In some arrangements, the exit bore 112, or at least a portion thereof, may comprise a circular cross-section perpendicular to the exit bore centreline 113. In some arrangements, this portion may be the portion of the exit bore 112 nearest to the nozzle outlet 114. The inlet portion 110 may have any shape or form, it may comprise a circular cross-section or any other suitable cross-section that can be manufactured, providing that there is a fluidic path such that fluid can flow through the nozzle 111, 11 la from the nozzle inlet 115 to the nozzle outlet 114.

Considering now FIG. 3B, this depicts another embodiment of the nozzle plate of the invention, similar to that of FIGS. 2A, 2B and 3A but where the nozzle 111b comprises a conical shape, where the nozzle cross-sectional area decreases from the nozzle inlet 115 to the nozzle outlet 114. It may be understood that, in various arrangements, some or all of the nozzle 111b may have a conical shape, for example, the exit bore 112 may have a conical shape and the rest of the nozzle 111b may have a different shape, as for the inlet portion 110 in FIG. 3A.

It may be understood that whilst, for simplicity, the nozzle plate 106 of FIG. 2A to FIG. 3B is depicted with a single nozzle 111, 111a, 111b in cross-section, the nozzle plate 106 may comprise a plurality of such nozzles 111, 111a, 111b. In some arrangements the exit bore centrelines 113 of the plurality of nozzles 111, 111a, 111b may be parallel to each other. In some arrangements the exit bores of the plurality of nozzles 111, 111a, 111b may be substantially identical to each other. In some arrangements the nozzles 111, 111a, 11b may be substantially identical to each other, depending on manufacturing tolerances. In some arrangements, the nozzles 111, 111a, 111b may be arranged in a row, or in a staggered row extending in the y-direction (into the page in FIGS. 2A to 3B), or any other suitable arrangement, for example the nozzle plate 106 may comprise one or more arrays of nozzles 111, 111a, 111b.

### Apparatus

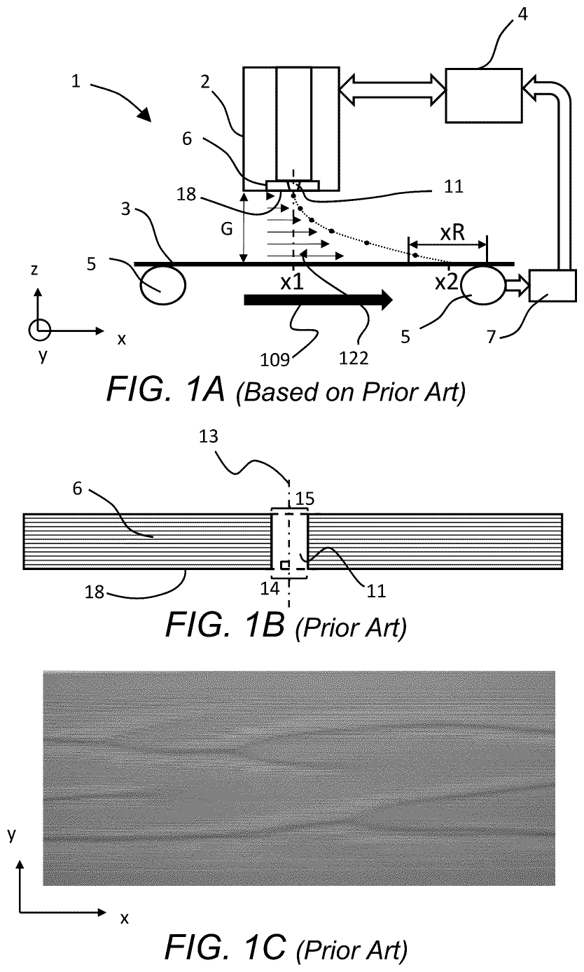

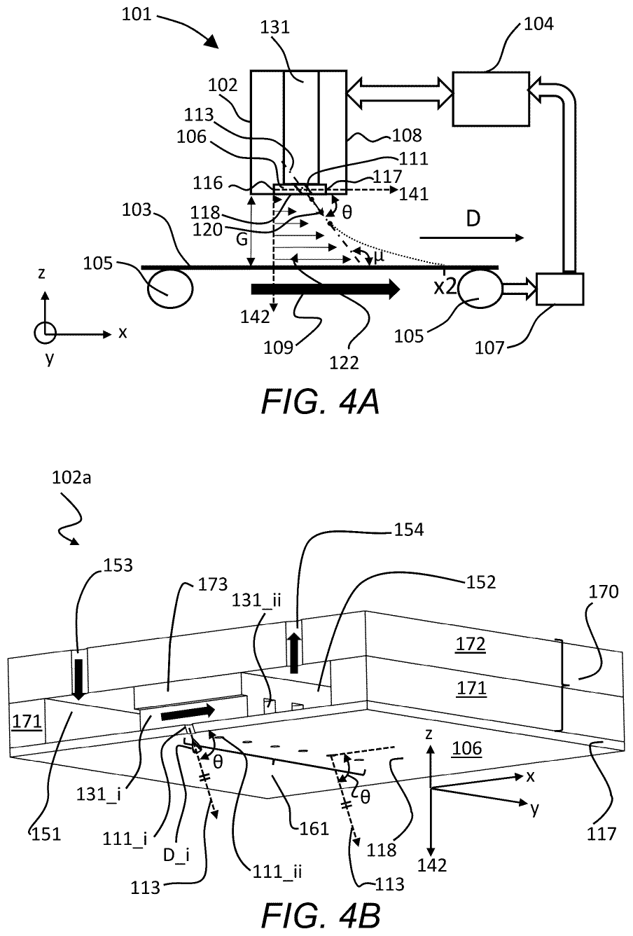

Turning now to FIG. 4A, this depicts a droplet ejection apparatus 101 according to an embodiment. It can be seen that it has a similar arrangement to the known test apparatus of FIG. 1A but that there is a droplet ejection device 102, such as a droplet ejection head, comprising a nozzle plate 106 according to the arrangement of FIG. 2A and FIG. 2B. It may be understood that any of the other nozzle plates 106 described herein with reference to different nozzles 111, 111a, 111b or any other nozzles described herein could also suitably be used in the droplet ejection device 102.

The droplet ejection device 102 is mounted above a deposition media 103 movable by a transport mechanism 105. The droplet ejection device 102 comprises a nozzle plate 106 having a nozzle 111 for ejecting droplets onto the deposition media 103 in response to signals sent by a controller 104. The nozzle plate 106 has a media facing surface 118 opposite the deposition media 103 and droplets of fluid exit the nozzle 111 through a nozzle outlet in the media facing surface 118. The droplet ejection device 102 is mounted such that there is a gap G between the deposition media 103 and the droplet ejection device 102 in a gap direction 142 (which is the negative z-direction). It can further be seen from FIG. 4A that the droplet ejection device 102 has a trailing edge 108 which is parallel to the trailing edge 117 of the nozzle plate 106 such that the exit bore centreline 113 is inclined in a direction towards the trailing edge 108 of the droplet ejection device 102, and the trailing edges are downstream in the deposition media movement direction.

The droplet ejection device 102 may further comprise a fluid chamber 131 fluidically connected to the nozzle 111 so as to supply fluid to the nozzle 111 and to eject a droplet when one or more walls of the fluid chamber 131 are actuated. In order to supply fluid to the fluid chamber 131, the droplet ejection device may further comprise an inlet manifold (not shown) fluidically connected to both the fluid chamber 131 and to a fluid source or a fluid supply (not shown). The droplet ejection device 102 may comprise a plurality of nozzles 111, each fluidically connected to a fluid chamber 131. In this case, the inlet manifold may be fluidically connected to a plurality of fluid chambers 131.

The droplet ejection apparatus 101 comprises at least one nozzle plate 106, according to any of the arrangements described herein, arranged in a droplet ejection device 102, as described herein, and a deposition media movement apparatus 105 to move the deposition media 103. It may be understood that, in some arrangements, the droplet ejection apparatus 101 may comprise one or more droplet ejection devices 102 (such as inkjet printheads), so as to span the deposition media 103 in the y-direction, in order that the entire width of the deposition media can be addressed at one time.

In the droplet ejection apparatus 101 of FIG. 4A, the deposition media 103 is parallel to the media facing surface 118. However, it may be understood that the droplet ejection device 102 may be ejecting fluid for deposition onto media that is largely planar but not completely flat, e.g. quasi-flat media, for example textured ceramic tiles, or other textured surfaces. In such cases, it may be understood that the media facing surface 118 is parallel to the surface on which the deposition media 103 is transported and substantially parallel to the deposition media 103. In general, for flat or quasi-flat media, the droplet deposition apparatus 101 may be arranged such that the portion of the deposition media 103 positioned parallel to the media facing surface 118 of the nozzle plate 106 comprises substantially all of the distance from the leading edge 116 to the trailing edge 117 of the nozzle plate 106. In an arrangement, such as that of FIG. 4A, the media movement direction 109 is parallel to the media facing surface 118, e.g. parallel to a line drawn from the leading edge 116 to the trailing edge 117 of the nozzle plate 106.

In the example of FIG. 4A, the media movement direction 109 is also parallel to the x-direction, and moves downstream relative to the media facing surface 118 (where the downstream direction D may be considered as a line parallel to the media facing surface 118 and drawn from the leading edge 116 to the trailing edge 117 of the nozzle plate 106).

Further, it may be understood that in other arrangements, for example when printing onto fabric or lengths of paper, only a portion of the deposition media 103 may be parallel to the media facing surface 118 due to the design of the deposition media movement apparatus 105. Further, it may be understood that the deposition media 103 may be moved such that it has a portion that is parallel to the media facing surface 118. For example, a bottle may be rotated relative to the droplet deposition device 102 and the deposition media movement apparatus 105 may be arranged to move the bottle so that the ejected droplets land on the bottle at a chosen location, building a printed image around the bottle as it turns. Therefore, when printing onto curved surfaces, such as bottles or other objects, or when addressing complex 3D shapes the deposition media movement apparatus 105 may be arranged such that, in operation, at least a portion of the deposition media 103, as it is moved by the deposition media movement apparatus 105, is positioned parallel to the media facing surface 118 of the nozzle plate 106.

It may be understood that the arrangement will be such that this portion of the deposition media 103 will comprise at least the x position, x2, where it is desired that the droplets will land.

It follows that, when using such deposition media 103, the droplet ejection apparatus 101 may be arranged such that the droplets ejected by the droplet ejection device 102 land on the desired portion of the deposition media 103, and that this may not be the x-position where the trajectory 120 intersects with the deposition media 103. It may further be understood that the droplet landing point may be downstream of the nozzle outlet 114 due to downstream travel of the droplets in the gap G. In use, therefore, a plurality of droplets of fluid may be ejected from the nozzle 111 at an acute inclination angle θ to the media facing surface 118 and inclined in the downstream direction D such that the droplets land on the media at a desired position, such that there is improved uniformity of the position of the droplets when they land on the media surface across the width of the media. In other words, where there is a plurality of nozzles 111 arranged in the y-direction (into the page in FIG. 4A) the droplets that they eject land at a more consistent x-position on the deposition media 103. More preferably, the droplets land at or close to the x-position x2, such that any deviations from the x-position, x2, are greatly reduced and preferably not visible to the naked eye. In some arrangements, droplets of fluid may be ejected from the nozzle 111 at an inclination angle θ between 74° and 68°, more preferably between 72° and 70°.

It may be understood that the extent of allowable deviation between droplets emanating from the plurality of nozzles 111 may depend on the application and the degree of resolution required in the printed image. For example, in some arrangements, where greater visual fidelity is required, an average standard deviation in the y-direction of less than 4.4 may be preferred, whereas in other applications, requiring less accuracy, a standard deviation of less than 5.2 or less than 7.2 may be adequate. In still further applications, requiring even less accuracy, a standard deviation of less than 8.3 may be acceptable.

It may further be understood that where there are a plurality of nozzles 111, droplets may be ejected from one or more nozzles 111, depending on print instructions, so as to produce the required image on the media. For example at different points in time the controller 104 may send different signals to the droplet ejection device 102. In response to the different signals sent by the controller 104, the droplet ejection device 102 may eject no droplets, one or more droplets, or droplets from all of the plurality of nozzles 111 onto the deposition media so as to produce the required image.

FIG. 4B depicts a detail of part of a droplet ejection device 102a comprising an actuator component 170 and a nozzle plate 106. As can be seen from FIG. 4B, there are a plurality of nozzles 111, numbered 111_i, 111_ii, etc. arranged in a row 161 in the nozzle plate 106. The nozzle plate 106 is fixedly attached to the actuator component 170, which comprises a substrate 172, a strip of piezoelectric material 173 and boundary sections 171. Each nozzle 111 is fluidically connected to a corresponding fluid chamber 131_i, 131_ii, etc., formed in the strip of piezoelectric material 173. The fluid chambers 131 are fluidically connected to manifold chambers 151, 152 which are bounded by the boundary section 171 and the substrate 172. Each of the manifold chambers 151, 152 is fluidically connected to a respective port 153, 154. This arrangement can be used to supply fluid to the fluid chambers 131 from both sides, or in a so-called throughflow arrangement where one port and manifold chamber act as an inlet port and an inlet manifold chamber and the other port and manifold chamber act as an outlet port and an outlet manifold chamber.

The plurality of nozzles 111 in the row 161 are arranged such that their respective exit bore centrelines 113 may be parallel to each other, as indicated by the parallel pairs of lines on the exit bore centrelines 113 in FIG. 4B. In some arrangements the exit bores of the plurality of nozzles 111 may be substantially identical to each other. In some arrangements the nozzles 111 may be substantially identical to each other, depending on manufacturing tolerances.

In operation, a throughflow arrangement sees fluid pass through the fluid chambers 131 from the inlet manifold chamber (e.g. manifold chamber 151) to the outlet manifold chamber (e.g. manifold chamber 152). When one or more walls of a fluid chamber (e.g. 131_i) are actuated, some of the fluid in the fluid chamber 131_i will be ejected through the respective nozzle 111_i at the inclination angle θ of the outlet bore centreline 113 to form a droplet (e.g. D_i). In other words, the droplet ejection device comprises at least one fluid chamber 131, located adjacent to and fluidically connected to at least one nozzle 111, so as, in use, to supply fluid to be ejected through said at least one nozzle 111. The nozzle inlet 115 of the one or more nozzles 111 may be located in the centre of the fluid chamber 131 in the fluid chamber width direction (the fluid chamber width direction is into the page in FIG. 4A and parallel to the row direction 143 in FIG. 4B) such that the nozzle comprises an opening, or fluid inlet 115, into the fluid chamber 131 where the opening is located centrally in the fluid chamber 131 in the fluid chamber width direction.

### Exemplary Data

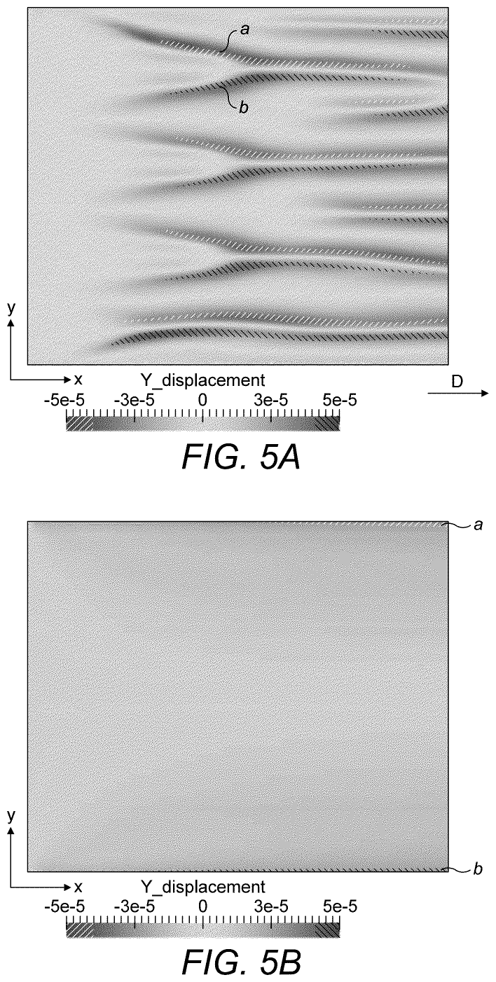

FIG. 5A and FIG. 5B depict the results of two CFD simulations made using OpenFOAM™, both are simulations of single pass printing using a Xaar™ 1003 printhead. FIG. 5A depicts a simulation based on a test droplet ejection device (Test Case) of a conventional design where the nozzle exit bore centreline 113 is perpendicular to the media facing surface 118 and FIG. 5B depicts a simulation based on a droplet ejection device according to an embodiment of the invention (Embodiment Case), where the exit bore centreline 113 is inclined at an inclination angle θ=70° to the media facing surface 118 in the downstream direction D (e.g. it is inclined downstream at an angle of 20° relative to a line perpendicular to the media facing surface 118, in other words inclined 20° relative to the nozzle exit bore centreline of the Test Case device). In both cases, the print frequency is 6 kHz, the gap G between the droplet ejection device and the deposition media is 5 mm, the initial droplet speed is 8 ms⁻¹, the resolution is 360 DPI (dots per inch) in the print (x-direction) and crossprint (y-direction), and the droplet volume is 12 picolitres (pL). The simulated patterns, are similar to that in FIG. 1C, in that they depict a simulation of a printed image caused by main droplet deviation. The shading in FIG. 5A and FIG. 5B depicts the droplet deviation in the positive and negative y-directions (y-displacement) with “0” being zero deviation. For greater clarity the greatest levels of droplet deviation in the negative y-direction have been overlaid with white hatching and the greatest levels of droplet deviation in the positive y-direction have been overlaid with black hatching, indicated by a and b respectively.

It can be seen that there are significant levels of droplet deviation in the y-direction in FIG. 5A, depicting a simulation for the Test Case, producing visible woodgraining effects in the image. In FIG. 5B, depicting a simulation for the Embodiment case, the majority of the image has much lower levels of droplet deviation, with the hatched overlays a and b being restricted to narrow regions at the edges of the image in the y-direction. It can clearly be seen by comparing FIG. 5A (Test Case) and FIG. 5B (Embodiment Case) that using nozzles 111 whose exit bore centreline 113 is inclined at an inclination angle θ=70° to the media facing surface 118 in the downstream direction D has significantly reduced the woodgraining effect.

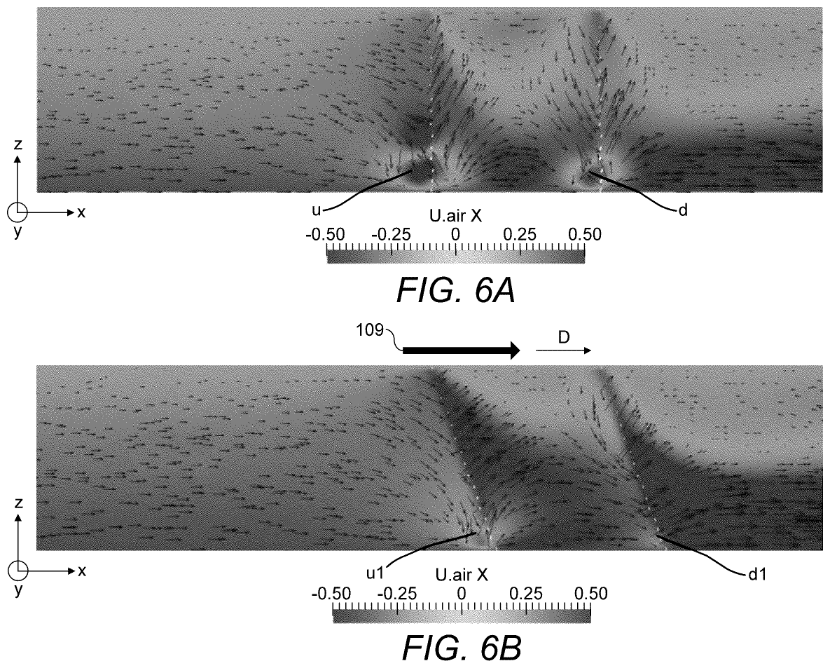

FIG. 6A depicts a cross-section in the z-x plane from the same CFD calculation as that used to produce FIG. 5A (i.e. for the Test Case) and FIG. 6B depicts the same cross-section as FIG. 6A for the Embodiment Case from the CFD calculation used to produce FIG. 5B. The shading indicates the air speed in the x-direction (U.air X (ms⁻¹)) and the black arrows indicate the flow direction, with their length being proportional to the air speed.

Without wishing to be bound to any particular theory, the inventor postulates that a possible explanation for the woodgraining effect in single pass printing, as shown in FIG. 5A, is the interaction between an impinging jet, created by the motion of the ejected droplets, and the forced air flow in the gap G, as described in the following sentences. When a droplet is ejected from the nozzle it travels to the deposition media 3, pushing air in front of itself. This causes a transfer of kinetic energy from the droplet to the surrounding air. As a consequence, an impinging air jet is created. When this jet hits the deposition media, it ‘splashes’ and kinetic energy is transferred in every direction. If one considers such a jet in 2 dimensions, as shown in FIG. 6A, one can see that it creates two vortices: left and right. This impinging air jet interacts with the forced air flow in the gap G (Couette flow—indicated by horizontal arrows 122 in FIG. 1A (and also in FIG. 4A)) caused by the moving deposition media 3. With reference to the media movement direction 109 and the downstream direction D, the left and right vortices can be labelled as upstream (u) and downstream (d) vortices.

The air that is transported with the deposition media 3 must somehow be delivered to the downstream side of the impinging jet (where there are multiple nozzles and hence multiple droplets, this is also known as a “drop curtain”). Because the drop curtain acts as an obstacle, the air transported with the moving deposition media 3 is trapped upstream of the curtain. It also interacts with the upstream vortices caused by the impinging jet. All of this causes the vortices to be constantly fed with air incoming with the deposition media 3. This results in the growth of the upstream vortex, which eventually becomes so large that it penetrates the drop curtain, causing the ejected droplets to be deflected and therefore resulting in the visual effect know as woodgrain. The inventor postulates that, when droplets are ejected from the nozzles 111 at an acute inclination angle θ to the first surface, in the downstream direction D as shown in FIG. 4A, the strength of the upstream vortex (ul) is significantly reduced (as seen in FIG. 6B), and consequently the woodgraining effect can be reduced. The downstream vortex (dl) is also significantly reduced in strength.

Turning now to Tables 1 and 2, these show the standard deviation of the droplet landing displacement in the y-direction. The standard deviations were determined by running a series of CFD simulations for the Test Case and Embodiment Case described above with reference to FIG. 5A and FIG. 5B. A range of droplet speeds (ms⁻¹) and droplet volumes (pL) were used for a model of the Xaar 1003 printhead operating at 6 kHz print frequency, 360 DPI in the print and crossprint directions with a gap G of 5 mm.

For each droplet speed and volume the standard deviation (μm) of the droplets in the y-direction (crossprint direction) was calculated; Table 1 has data for the Test Case and Table 2 is for the Embodiment Case, as described above with respect to FIG. 5A, FIG. 5B, FIG. 6A and FIG. 6B. It can be seen from both Table 1 and Table 2 that both droplet speed and droplet volume have an effect on the standard deviation, but that overall, the Embodiment Case has reduced the standard deviation compared to the Test Case except for the smallest and slowest droplets at 5 ms⁻¹ and 6 pL.

TABLE 1
Standard deviation of droplet landing displacement
in the y-direction (μm) for the Test Case

| Droplet | Droplet size (pL) | | | | | |
|---|---|---|---|---|---|---|
| speed (ms⁻¹) | 6 | 12 | 18 | 24 | 40 | 80 |
| 5 | 15.99 | 18.91 | 18.44 | 17.95 | 18.31 | 15.42 |
| 8 | 14.15 | 13.27 | 12.92 | 13.16 | 11.77 | 9.11 |
| 10 | 11.16 | 10.24 | 10.94 | 10.76 | 9.08 | 6.96 |
| 12 | 9.27 | 8.95 | 9.16 | 8.63 | 7.13 | 5.74 |
| 15 | 7.14 | 7.62 | 7.15 | 6.69 | 5.42 | 4.35 |

TABLE 2
Standard deviation of droplet landing displacement
in the y-direction (μm) for the Embodiment Case

| Droplet | Droplet size (pL) | | | | | |
|---|---|---|---|---|---|---|
| speed (ms⁻¹) | 6 | 12 | 18 | 24 | 40 | 80 |
| 5 | 26.53 | 13.84 | 10.79 | 9.46 | 8.10 | 7.46 |
| 8 | 12.18 | 8.27 | 7.13 | 6.53 | 6.19 | 5.6 |
| 10 | 8.83 | 6.41 | 5.72 | 5.51 | 5.23 | 4.94 |
| 12 | 6.88 | 5.27 | 4.86 | 4.82 | 4.61 | 4.57 |
| 15 | 5.09 | 4.16 | 4.04 | 4.10 | 3.98 | 4.57 |

It may be understood that any of the nozzle arrangements as described herein may be used in a droplet ejection head and/or a droplet ejection apparatus as described herein without departing from the scope of the invention.

1. A nozzle plate for a droplet ejection device, the nozzle plate comprising:
a first, media facing surface and, opposing it, a second, back surface; and
at least one nozzle:
wherein the nozzle plate further comprises a leading edge and a trailing edge;
wherein said at least one nozzle passes through the nozzle plate from the second surface to the first surface:
wherein said at least one nozzle comprises an exit bore having an exit bore centreline and wherein the exit bore centreline is inclined at an oblique acute inclination angle θ to the first surface; and
wherein the exit bore centreline is inclined in a direction towards said trailing edge and is adapted such that, in use, one or more droplets are ejected from the nozzle at an the acute inclination angle θ to the first surface.

2. (canceled)

3. The nozzle plate according to claim 1, wherein the acute inclination angle θ is between 74° and 68°.

4. The nozzle plate according to claim 3, wherein the acute inclination angle θ is between 72° and 70°.

5. The nozzle plate according to claim 1, wherein at least a portion of the exit bore along the exit bore centreline has a circular cross-section.

6. The nozzle plate according to claim 1, wherein the nozzle plate comprises a plurality of said nozzles.

7. The nozzle plate according to claim 6, wherein the exit bore centrelines of the plurality of said nozzles are parallel to each other.

8. The nozzle plate according to claim 6, wherein the plurality of said nozzle exit bores are substantially identical to each other.

9. The nozzle plate according to claim 1, wherein the nozzle plate comprises one or more arrays of nozzles.

10. A droplet ejection device comprising the nozzle plate according to claim 1.

11. The droplet ejection device according to claim 10, comprising a trailing edge, wherein the trailing edge of the droplet ejection head is parallel to the trailing edge of the nozzle plate.

12. The droplet ejection device according to claim 10, wherein said droplet ejection device comprises at least one fluid chamber, located adjacent to and fluidically connected to said at least one nozzle, and adapted so as, in use, to supply fluid to be ejected through said at least one nozzle.

13. The droplet ejection device according to claim 10, wherein the nozzle plate comprises a plurality of said nozzles, and wherein each of said plurality of nozzles is fluidically connected to a respective fluid chamber.

14. A droplet ejection apparatus comprising at least one droplet ejection device according to claim 10, and a deposition media movement apparatus.

15. The droplet ejection apparatus according to claim 14, wherein the deposition media movement apparatus is arranged such that, in operation, at least a portion of the deposition media is positioned parallel to the first surface while it is moved by the deposition media movement apparatus.

16. The droplet ejection apparatus according to claim 14, wherein said droplet ejection apparatus is arranged as a single-pass printer.

17. A method of operating the droplet ejection apparatus according to claim 14, comprising ejecting droplets from the at least one nozzle at the acute inclination angle θ to the first surface.

18. The method of operating a droplet ejection apparatus according to claim 17, wherein the acute inclination angle θ is between 74° and 68°.

19. The method of operating a droplet ejection apparatus according to claim 17, wherein the apparatus has a width in a y-direction and droplets are ejected from a plurality of nozzles extending in the y direction and wherein a standard deviation of landing positions of the ejected droplets on the deposition media in the y-direction is less than 8.3.

20. The method of operating a droplet ejection apparatus according to claim 17, wherein the droplet ejection apparatus is operating in a single-pass printing mode.
